(19) United States
(12) Patent Application Publication
(10) Pub. No.: US 2005/0206705 A1
(43) Pub. Date: Sep. 22, 2005

(54) Ink-jet imaging on offset media

(76) Inventors: Zeying Ma, San Diego, CA (US); Gregg A. Lane, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/803,225

(22) Filed: Mar. 16, 2004

(51) Int. Cl. C09D 11/00; B41J 2/01

(52) U.S. Cl. 347/103; 347/95; 347/100

(57) ABSTRACT

The present invention is draw to the use of post calendaring of ink-jet produced images on offset media to improve smudge resistance and image quality. More specifically, a system for printing durable ink-jet ink images can comprise offset media; an ink-jet ink; and a calendaring device. The ink-jet ink can include a pigment colorant, and can be configured to be printed on the offset media. The calendaring device can be configured for applying pressure to offset media once the ink-jet ink is printed thereon. A method is also provide that comprises steps of ink-jetting an ink-jet ink onto offset media to form a printed image, wherein the ink-jet ink includes a pigment colorant; and applying pressure to the printed image such that a physical property of the printed image is altered by the pressure.

### FIELD OF THE INVENTION

The present invention relates generally to ink-jet imaging. More particularly, the present invention relates to systems and methods for ink-jet printing on commercial offset media.

### BACKGROUND OF THE INVENTION

Papers used for ink-jet printing have typically included high-quality or wood-free papers designed to have high ink absorptivity. These papers are functionally good for ink-jet printing because the inks may be absorbed readily and dry quickly. Such papers often do not allow for a crisp or sharp image. As such, specialty media has been developed specifically for use with ink-jet printers, such as porous coated media and polymer swellable media. These papers provide good image quality and other desirable printing characteristics. However, there is a large commercial offset printing market that utilizes commercial offset paper which has largely been incompatible with aqueous ink-jet printing technology.

Commercial offset paper, because of its nonporous smooth surface, could potentially provide a good printing surface for a crisp image. However, commercial offset coated papers are significantly different than office plain papers or ink-jet specific specialty media papers designed for ink-jet printing. Typically, with commercial offset papers, the smooth non-porous surface comprises a coating which requires more time for aqueous fluids to penetrate than plain or ink-jet specialty papers. This is because diffusion-type adsorption must generally occur with offset papers as compared with capillary-type absorption which typically occurs with respect to standard office paper and some ink-jet specialty papers. Additionally, offset coatings contain polymers that are more hydrophobic, e.g., styrene-butadiene based, than coatings specifically designed for ink-jet ink applications, e.g., water-soluble polymers such as polyvinyl alcohol. Thus, because offset coatings are typically hydrophobic, have poor aqueous liquid penetration, and are smooth and non-porous, these coatings tend to interact poorly with water-based inks. In addition, classic ink-jet solvents such as glycols and diols tend to perform poorly on these coatings, showing long dry times and poor spreading characteristics.

Because commercial offset paper provides a smooth surface for printing and would provide a convenient and inexpensive alternative to the use of specialty papers, it would be useful provide aqueous-based ink-jet ink printing system which can be used with commercial offset media, while providing good image smudge/smear resistance and gloss retention.

### SUMMARY OF THE INVENTION

It has been recognized that it would be advantageous to provide systems and methods for ink-jet printing on commercial offset media, while obtaining both good smudge/smear resistance as well as good image gloss. As such, a system for printing durable ink-jet ink images can include offset media, an ink-jet ink, and a calendaring device. The ink-jet ink can include a pigment colorant, and can be configured to be printed onto the offset media. Further, the calendaring device can be configured to apply pressure to the offset media once the ink-jet ink is printed thereon.

In an alternative embodiment, a method of printing images on offset media can comprise steps of ink-jetting an ink-jet ink onto offset media to form a printed image, wherein the ink-jet ink includes a pigment colorant; and applying pressure to the printed image such that a physical property of the printed image is altered by the pressure.

Additional features and advantages of the invention will be apparent from the detailed description which illustrates, by way of example, features of the invention.

### DETAILED DESCRIPTION OF THE PREFERRED EMBODIMENT(S)

Before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

In describing and claiming the present invention, the following terminology will be used.

The singular forms “a,” “an,” and “the” include plural referents unless the context clearly dictates otherwise. Thus, for example, reference to “a pigment” includes reference to one or more of such materials.

The term “substantially” when used with another term shall include from mostly to completely.

“Offset media” is generally a coated printing media that is relatively nonporous and which exhibits increased opacity and ink penetration resistance. The coatings are generally more hydrophobic than typical ink-jet printing media, and can include coatings having pigment particulates and binders, such as styrene-butadiene copolymer. The term “offset media” includes both coated media as well as media printed with more hydrophobic offset inks. Examples of offset media include Lustro Laser, Kromekote, Cosmo, and Utopia Dull.

As used herein, “liquid vehicle” is defined to include liquid compositions that can be used to carry colorants or crashing agents to a substrate. Liquid vehicles are well known in the art, and a wide variety of liquid vehicles may be used in accordance with embodiments of the present invention. Such liquid vehicles may include a mixture of a variety of different agents, including without limitation, surfactants, solvents, co-solvents, buffers, biocides, viscosity modifiers, sequestering agents, stabilizing agents, and water. The liquid vehicle can also carry other additives such as polymers or latex particulates in some embodiments.

An “ink” or “ink-jet ink” refers to a solution composition that can comprise a liquid vehicle and a pigment colorant. The liquid vehicle can be configured to be stable with the pigment through a broad range of solution characteristics, and can be configured for ink-jet printing. The pigment can be a self-dispersed pigment or a polymer dispersed pigment, and is present primarily for providing color to the ink-jet ink. Though the present invention utilizes pigment colorants, optionally, dyes can also be present in the ink-jet ink.

The term “pigment” refers to particulate colorants that can be dispersed in a liquid vehicle to form an ink-jet ink. Pigments are typically associated with dispersants such as polymers, small molecules, and/or surfactants. The dispersants can be chemically attached to the surface of the particulate, such as to provide a surface charge or other property. Alternatively, an unattached dispersant can be included in a formulation to provide favorable dispersion properties to the pigment. For example, the dispersant can be surface adsorbed or coated on the pigment, as is known in the art. Dispersant modification of a pigment can aid a pigment in becoming and/or substantially remaining dispersed.

A “fixing fluid” or “fixer composition” refers to a solution composition that comprises a liquid vehicle and a crashing agent. The liquid vehicle combined with the crashing agent can be configured to be chemically stable under a broad range of solution characteristics, and can be configured for ink-jet printing. The crashing agent can be a cationic polymer, a multivalent metal ion or ionic group, and/or an acid. The crashing agent is typically configured to crash or react with at least one compositional component of an associated ink-jet ink (to be overprinted or underprinted printed on a substrate therewith). Typically, the compositional component that is reactive with the crashing agent can be the pigment colorant, and/or a latex particulate, if present.

The term “crashing agent” refers to any single chemical or combination of chemicals in a fixer composition that can facilitate the desolubilization or precipitation of one or more component(s) of an ink-jet ink. The desolubilizing can be accomplished by proton transfer from collision or close proximity of the crashing agent with the pigment and/or another ink-jet ink component, or alternatively, the desolubilizing can be accomplished by component associations induced by the crashing agent and/or component associations occurring with the crashing agent. Other crashing or reaction mechanisms can also occur.

As used herein, “bleed” refers to the tendency of ink to run into and mix with adjacently printed inks. Bleed typically occurs prior to adjacently printed inks fully drying on a substrate. The degree of bleed will depend on a variety of factors such as the drying speed of the ink, ink chemistry, i.e. the presence of reactive or non-reactive bleed control mechanisms, and type of substrate, among other variables. For example, as offset media typically does not allow for rapid penetration of typical ink-jet inks, optionally, a fixer composition can be used to prevent bleed and/or coalescence prior to post calendaring. Similarly, the term “feathering” refers to rough edges that occur at the interface between a printed image and an unprinted portion of the substrate. Both of these characteristics are typically undesirable.

The terms “overprinting” and “underprinting” refer to processes of printing where a first printing solution is printed onto a substrate, and subsequently, a second printing solution is printed onto the first printed solution. The first printing solution would be said to be underprinted with respect to the second printing solution. The second printing solution would be said to be overprinted with respect to the first printing solution. For example, in some embodiments, an ink can be printed onto offset media, and then, a fixing fluid can be printed onto the ink. In this example, the fixing fluid is overprinted with respect to the ink. Alternatively, a fixing fluid can be printed onto an offset media substrate, and then, an ink can be printed onto the fixing fluid. In this latter example, the fixing fluid is underprinted with respect to the ink. Additionally, simultaneous printing of two fluids is also within the definition of overprinting and/or underprinting, as simultaneously applied multiple drops of fluid during a jetting process will provide both overprinting and underprinting of either fluids with respect to the other.

It is to be understood that when referring to printing or jetting an ink-jet ink or fixing fluid “on” or “onto” offset media, embodiments wherein both underprinting and overprinting with respect to the ink or fluid printed “on” the offset media are included. For example, if an ink-jet ink is said to be configured for printing “on” offset media, and a fixing fluid is said to be configured for being underprinted with respect to the ink-jet ink, then technically, the ink-jet ink is printed on the fixing fluid (which is printed on the offset media). In this example, the ink-jet ink would still be defined as being configured for printing on the offset media. In other words, the presence of an intervening underprinted layer between the ink-jet ink and the offset media substrate does not deter from the fact that the ink-jet ink is configured for printing on the offset media. This same distinction is also true with respect to related methods. For example, method steps wherein ink-jet ink and a fixing fluid are printed onto offset media do not infer that one cannot be overprinted or underprinted with respect to the other.

Temperatures, pressures, ratios, concentrations, amounts, molecular sizes, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of about 1 wt % to about 20 wt % should be interpreted to include not only the explicitly recited concentration limits of 1 wt % to about 20 wt %, but also to include individual concentrations such as 2 wt %, 3 wt %, 4 wt %, and sub-ranges such as 5 wt % to 15 wt %, 10 wt % to 20 wt %, etc.

Due to the relative nonporous and hydrophobic nature of coated offset media and offset ink, more conventional water-based ink-jet inks are not typically durable, and exhibit bleed and coalescence when printed thereon. It has been recognized that these problems can be overcome by using pigmented inks, and optionally, underprinteing or overprinting the ink-jet ink with a fixer composition. However, particularly with respect to printed images that utilize fixer composition with a pigmented ink-jet ink, reaction between the ink-jet ink and the fixer composition can destroy gloss inherently present in the offset media. Thus, it has further been recognized that utilizing a post calendaring process after printing such an image can be used to regain image gloss loss and/or improve durability, as is desirable in some applications.

Thus, in accordance with embodiments of the present invention, a system for printing durable ink-jet ink images can include offset media, an ink-jet ink, and a calendaring device. The ink-jet ink can include a pigment colorant, and can be configured to be ink-jet printed onto the offset media. Further, the calendaring device can be configured for applying pressure to the offset media once the ink-jet ink is printed thereon.

In an alternative embodiment, a method of printing images on offset media can comprise steps of ink-jetting an ink-jet ink onto offset media to form a printed image, wherein the ink-jet ink includes a pigment colorant; and applying pressure to the printed image such that a physical property of the printed image is altered by the pressure. Exemplary physical properties include smoothness and/or flow. For example, upon applying pressure, the printed image can be modified from having a textured profile to a more smooth profile, or alternatively, the printed image can be temporarily modified from a more solid configuration to a more liquid configuration, thereby allowing for the return of gloss to the image, even after drying.

With respect to both the system and method described herein, other optional components or steps, respectively, can be present. For example, a fluid-jet pen containing a fixer composition can be present in the system, and the fluid-jet pen or another similar device can be used for underprinting or overprinting fixer composition with respect to the ink-jet ink prior to calendaring. In another embodiment, latex particulates can be dispersed in the ink-jet ink, and/or in an overcoating composition to be applied after application of fixer and/or ink. In either case, whether present in the ink-jet ink or the overcoating composition, the latex particulates can be present at from 0.1 wt % to 15 wt %. In a more detailed aspect, the latex particulates can be present at from 1 wt % to 5 wt %. Other variations can also be present as well.

Ink-Jet Ink

Ink-jet inks that can be used in accordance with embodiments of the present invention can include a liquid vehicle and a pigment. In one embodiment, the pigment can have a dispersant chemically tethered thereto. Such an arrangement can provide good results with respect to dry time and durability. Alternatively, the pigment can be present with a dispersant that is not chemically attached, but is admixed with, coated on, or adsorbed on the pigment. Regardless of the type of pigment system used, it can be of any color. Further, the pigment can be neutral, cationic, anionic, zwitterionic, hydrophilic, and/or hydrophobic, without limitation.

In further detail with respect to the pigment, chemical tethering of dispersant to the pigment can be through hydrophobic-hydrophilic attraction, ionic association, covalent bonding, or other known chemical attachment mechanism. This chemical attraction or bonding between the dispersant and the pigment can be at a single location or area, or at multiple locations over substantially the entire pigment particulate. Exemplary pigments of this type that are commercially available include CaboJet 200, CaboJet 300, and the like. Furthermore, if the pigment is chemically modified and the dispersant is a polymeric dispersant, in one embodiment, from 1 wt % to 50 wt % of the polymeric dispersant can be directly attached to the surface of the pigment. The balance of the polymeric dispersant that is not directly attached to the surface of the pigment can be tethered to the polymeric dispersant portion that is attached to the pigment surface, thereby forming hair-like polymeric structures extending from the surface of the pigment. Such a pigment can be present in the ink-jet ink at from 0.5 wt % to 10 wt %, or any incremental range therein.

Alternatively, pigment dispersions can also be used that include pigments and non-chemically attached dispersants, such as dispersants associated with pigments by physical coating, adsorption, or admixture. The dispersant can be a polymer, surfactant, small molecule, or the like, as is known in the art. Water-soluble polymeric resin(s) can be used to disperse the pigment, as long as the resin(s) function to stabilize and disperse the pigment in solution. A polymeric resin that can be used includes those having a weight average molecular weight in a range of 1,000 Mw to 30,000 Mw, or any incremental range therein. For example, in a more detailed embodiment, the polymer can have a weight average molecular weight in a range from 3,000 Mw to 10,000 Mw. Specifically, the resin can be a polymer, block copolymer, tri-block copolymer, graft copolymer, random copolymer, or the like. Additionally, the polymer can include one or more monomers with characteristics such as hydrophilic, hydrophobic, neutral, cationic, anionic, amphoteric, and combinations thereof. Exemplary monomers that can be used to form such polymers and copolymers include, without limitation, styrene, styrene derivatives, vinylnaphthalene, vinylnaphthalene derivatives, aliphatic alcohol esters, of α-, β-ethylenically unsaturated carboxylic acids, acrylic acid, acrylic acid derivatives, maleic acid, maleic acid derivatives, itaconic acid, itaconic acid derivatives, fumaric acid and fumaric acid derivative, and the like, and combinations thereof. Examples of such pigment dispersion systems that can be used include Flexiverse from Sun Chemical, Sunsperse from Sun Chemical, and Acryjet from Rohm Ihaas. In one embodiment, the pigment particulates can be present in the ink-jet ink at from 0.5 wt % to 10 wt %, or any incremental range therein. With respect to the dispersant that is present in the pigment dispersion, once the pigment dispersion system is added to the ink-jet ink, the dispersant can be present in the ink-jet ink at from 0.5 wt % to 10 wt %.

Though not required, the ink-jet ink can also include latex particulates, typically provided by a latex-containing colloidal suspension. In one embodiment, the latex particulates can comprise randomly polymerized copolymers. The latex particulates can be substantially from 20 nm to 500 nm in one embodiment, and from 40 nm to 300 nm in size in another embodiment. With respect to molecular weight, the latex particulates can be substantially from 10,000 Mw to 2,000,000 Mw, and in another embodiment, from 40,000 Mw to 100,000 Mw. When mixed with the ink-jet ink, the water, dispersant, and/or other liquid of the suspension will mix with the liquid vehicle of the ink-jet ink, and the polymeric particulates of the latex-containing colloidal suspension can be present in the ink-jet ink at from 0.1 wt % to 15 wt % by solids.

Alternatively, the latex can be in a fluid separate from the ink-jet ink, and can be overprinted and/or underprinted with respect to the ink-jet ink. In other words, after printing an ink-jet ink in accordance with embodiments of the present invention, an optional overcoat composition can be applied to the ink-jet ink. In one embodiment, the overcoat composition can be of a similar composition as the ink-jet ink, absent the pigment colorant. For example, the polymeric particulates present in an overcoat composition that contains latex particulates can include latex particulates at from 0.1 wt % to 15 wt % by solids.

There are a number of compositions that can make up the polymeric particulates of the latex-containing colloidal suspensions, including randomly polymerized monomers. To illustrate by example, the plurality of randomly polymerized monomers can include various combinations of methyl methacrylate, methacryloyloxy ethyl succinate, ethylene glycol dimethacrylate, methacrylic acid, acrylic acid, itaconic acid, ethyl acrylate, ethyl methacrylate, benzyl acrylate, benzyl methacrylate, propyl acrylate, propyl methacrylate, hexyl acrylate, hexyl methacrylate, butyl acrylate, butyl methacrylate, octadecyl acrylate, octadecyl methacrylate, hydroxy ethyl acrylate, hydroxy ethyl methacrylate, hydroxy hexyl acrylate, hydroxy hexyl methacrylate, phenethyl acrylate, phenethyl methacrylate, vinyl propyl ketone, vinyl hexyl ketone, cyclohexyl acrylate, isopropyl acrylate, isopropyl methacrylate, isobutyl acrylate, isobutyl methacrylate, trifluoromethyl acrylate, trifluoromethyl methacrylate, trifluoro propyl acrylate, trifluoro propyl methacrylate, 2-ethylhexyl acrylate, 2-ethylhexyl methacrylate, iso-octyl acrylate, and iso-oictyl methacrylate. Other suitable monomers that can be used are described in WO 99/23182, which is incorporated herein by reference.

Though not required, in addition to the presence of the pigment, the ink-jet ink can further include additional pigments and/or one or more dye(s), depending on the affect desired to be achieved.

Fixer Composition

Optionally, fixer compositions can be configured for jetting on a substrate either before or after the ink-jet ink, such as by overprinting or underprinting with respect to the ink-jet ink. Typically, the fixer composition can be jetted from a separate pen, or from a separate jetting orifice(s) of the same pen, with respect to the ink-jet ink.

Fixer composition can include a liquid vehicle and a crashing agent, and the combination can be configured to be ink-jettable. Though colorant can be present in the fixing fluid, a substantially colorless fixing fluid exemplifies a typical embodiment. The crashing agent can be any crashing agent that acts to crash one or more ink-jet ink component, thereby improving durability and waterfastness of an ink-jet ink image printed on a media substrate. Though any functional amount of crashing agent can be present in the fixing fluid, from about 0.1 wt % to 10 wt % can be included.

The crashing agent can be a cationic polymer, a multivalent ion or ionic group, or an acid, for example. Many possible crashing agents within these categories, or others, can be used to crash one or more components of the ink-jet ink. For example, if the crashing agent is a cationic polymer, it can be one or more of polyvinylpyridines, polyalkylaminoethyl acrylates, polyalkylaminoethyl methacrylates, poly(vinyl imidazole), polyethyleneimines, polybiguanides, polyguanides, polyvinylamines, polyallylamines, polyacrylamines, polyacrylamides, polyquaternaryamines, cationic polyurathenes, aminecelluloses, and/or polysacchride amines.

If the crashing agent includes a multivalent ion or ionic group, it can be provided by one or more of multivalent metal nitrates (such as calcium nitrates and magnesium nitrates), EDTA salts, phosphonium halide salts, organic acids, and/or chloride salts. The chloride salt can be, for example, calcium chloride, magnesium chloride, or aluminum chloride.

If the crashing agent is an acid, it can be provided by one or more of succinic acid, glycolic acid, citric acid, nitric acid, hydrochloric acid, phosphoric acid, sulfuric acid, polyacrylic acid, acetic acid, malonic acid, maleic acid, ascorbic acid, glutaric acid, fumaric acid, tartaric acid, lactic acid, nitrous acid, boric acid, carbonic acid, carboxylic acids such as formic acid, chloroacetic acid, dichloroacetic acid, trichloroacetic acid, fluoroacetic acid, trimethylacetic acid, methoxyacetic acid, mercaptoacetic acid, propionic acid, butyric acid, valeric acid, caprioc acid, caprylic acid, capric acid, lauric acid, myristic acid, palmitic acid, stearic acid, oleic acid, rinolic acid, rinoleic acid, cyclohexanecarboxylic acid, phenylacetic acid, benzoic acid, o-toluic acid, m-toluic acid, p-toluic acid, o-chlorobenzoic acid, m-chlorobenzoic acid, p-chlorobenzoic acid, o-bromobenzoic acid, m-bromobenzoic acid, p-bromobenzoic acid, o-nitrobenzoic acid, m-nitrobenzoic acid, p-nitrobenzoic acid, oxalic acid, adipic acid, phthalic acid, isophthalic acid, terephthalic acid, salicylic acid, p-hydrobenzoic acid, anthranilic acid, m-aminobenzoic acid, p-aminobenzoic acid, benzenesulfonic acid, methylbenzenesulfonic acid, ethylbenzenesulfonic acid, dodecylbenzenesulfonic acid, 5-sulfosalicylic acid, 1-sulfonaphthalene, hexanesulfonic acid, octanesulfonic acid, dodecanesulfonic acid, amino acids such as glycine, alanine, valine, α-aminobutyric acid, α-aminobutryic acid, α-alanine, taurine, serine, α-amino-n-caprioc acid, leucine, norleucine, or phenylalanine.

Though many possible crashing agents have been listed, certain crashing agents can be more or less preferred for use in certain applications, as would be known by those skilled in the art after considering the present disclosure. For example, calcium nitrate or magnesium nitrate can be used with state of the art ink-jet pens. Though such composition and pen combinations are functional, these compositions can damage these ink-jet pens over time, as well as provide other unfavorable characteristics. Though less preferred, such acidic agents are still within the scope of the present invention. To cite another example, one can consider the pigment present in the ink-jet ink composition when selecting an appropriate crashing agent. Certain crashing agents will work better with certain pigment surface treatments, as would be apparent to one skilled in the art after considering the present disclosure.

Liquid Vehicle

The liquid vehicles and components described herein are applicable with respect to the ink-jet ink, the optional fixer composition, and/or the optional overcoat. It is understood that these components are exemplary and do not limit the scope of vehicle components that can be used. In some embodiments of the present invention, it may be favorable for the liquid vehicle to comprise water-soluble organic solvents, co-solvents, and other additives as a liquid medium. The balance of any embodiment formulation can be water, or other vehicle component known in the art.

The water-soluble organic solvents and/or co-solvents that can be used in the present invention include, but is not limited to, dimethylformamide, dimethylacetamide, acetone, tetrahydrofuran, dioxane, polyethylene glycol polypropylene glycol, ethylene glycol, propylene glycol, butylene glycol, 1,2-hexanediol, triethylene glycol, 1,2,6-hexanetriol, thiodiglycol, hexylene glycol, diethylene glycol, ethylene glycol methyl ether, diethylene glycol monomethyl ether, triethylene glycol monomethyl ether, ethanol isopropyl alcohol, n-butyl alcohol, isobutyl alcohol, glycerol, n-methyl-2-pyrrolidone, 1,3-dimethylimidazolidinone, triethanolamine, sulfolane, dimethyl sulfoxide, and the like, as well as other amines, ketones, ethers, polyalkylene glycols, alkylene glycols, lower alkyl ethers of polyhydric alcohols, monohydric alcohols, and combinations thereof.

Additionally, the liquid vehicle can comprise other solvents or wetting agents commonly referred to as humectants. Though there is some overlap as to what is considered a humectant and what is considered a solvent, for convenience, both humectants and/or solvents can be used, regardless of their designation. Humectants can be present to enhance the longevity of solution and solubility characteristics, which can be maintained by retention of moisture within the liquid vehicle. Examples of humectants include, but are not limited to, nitrogen-containing compounds such as urea, thiourea, ethylene urea, alkylurea, alkylthiourea, dialkylurea, dialkylthiourea; sugars such as fucitol, mannitol, and inositol, and combinations thereof.

The liquid vehicle can also comprise solution characteristic modifiers such as viscosity modifiers, pH adjusters, preservatives, various types of surfactant, antioxidants, and evaporation accelerators. Examples of surfactants that can be used include primary, secondary, and tertiary amine salt compounds such as hydrochloric acid salts, acetic acid salts of laurylamine, coconut amine, stearylamine, rosin amine; quaternary ammonium salt type compounds such as lauryltrimethylammonium chloride, cetyltrimethylammonium chloride, benzyltributylammonium chloride, benzalkonium chloride, etc.; pyridinium salt type compounds such as cetylpyridinium chloride, cetylpyridinium bromide, etc.; nonionic surfactant such as polyoxyethylene alkyl ethers, polyoxyethylene alkyl esters, acetylene alcohols, acetylene glycols; and other surfactants such as 2-heptadecenyl-hydroxyethylimidazoline, dihydroxyethylstearylamine, stearyldimethylbetaine, and lauryldihydroxyethylbetaine; and combinations thereof.

pH adjustors that can be used comprise base agents such as sodium hydroxide, lithium hydroxide, sodium carbonate, ammonium carbonate ammonia sodium acetate, ammonium acetate, morpholine, monoethanolamine, diethanolamine, triethanolamine, ethylmonoethanolamine, n-butyldiethanolamine, di-n-butylethanolamine, monoisopropanolamine, diisopropanolamine, and triisopropanolamine, and the like as well as combinations thereof. Additionally, pH adjustors can also comprise acidic agents that can be selected from the list of acidic crashing agents.

Consistent with the formulation of this invention, various other additives can be used to optimize the properties of the ink composition for specific applications. Examples of these additives are those added to inhibit the growth of harmful microorganisms. These additives may be biocides, fungicides, and other microbial agents, which are routinely used in liquid vehicle formulations. Examples of suitable microbial agents include, but are not limited to, Nuosept (Nudex, Inc.), Ucarcide (Union carbide Corp.), Vancide (R.T. Vanderbilt Co.), Proxel (ICI America), and combinations thereof. Sequestering agents, such as EDTA (ethylene diamine tetra acetic acid) and the like, may be included to eliminate the deleterious effects of heavy metal impurities.

Though common principles have been described with respect to the liquid vehicle for the ink-jet ink compositions, fixer compositions, latex overcoat compositions, ink-jet ink/latex compositions, etc., different liquid vehicles can be formulated for each in a common system. For example, if preparing an anionic pigment-containing ink-jet ink, an anionic or nonionic surfactant can be used to prevent crashing of the pigment. Alternatively, if preparing a fixer composition containing a cationic crashing agent, then a cationic or nonionic surfactant can be used in the fixer solution. In other words, considerations that would be known to those skilled in the art can be taken when preparing a liquid vehicle for use in accordance with principles of the present invention.

Post Calendaring

After printing on the offset media with the pigment-containing ink-jet ink (which can optionally be underprinted or overprinted with a fixer composition as described), a post calendaring process can be carried out to accomplish one or more desired results. For example, the application of pressure to printed image can physically alter the printed image by leveling and/or smoothing the printed image. In one embodiment, mechanical pressure, such as by smooth rollers, can be applied to the printed image causing it to change from a more textured state to a more smooth state. The pressure can cause ink-jet ink printed image to flow. In one embodiment, the pressure applied can be applied at from 500 psi to 3000 psi. Though this range is provided as a guideline, depending on the material used, various amounts of pressure/temperature can be applied.

Heat can also be applied with the pressure. For example, metal rollers can provide a means for applying pressure and heat simultaneously. If heat is applied, consideration as to the ink-jet ink composition and the offset media properties can provide guidance as to how much pressure and heat to apply, as would be known to one skilled in the art after considering the present disclosure. An exemplary range of temperature that can be applied is from 20° C. to 90° C.

With respect to selecting the amount of pressure, and optionally heat, to apply, one can consider that the application of too little pressure can be ineffective for providing gloss and smudge resistance, and if elevated temperature is used, the application of too much temperature can cause the image to transfer to the rollers. Other variations of the application of pressure and heat can also be carried out in accordance with embodiments of the present invention. For example, other devices other than rollers can be used to apply the pressure, such as a flat press that can apply direct pressure to the printed image. Alternatively, textures can be applied to the ink-jet ink during the post calendaring process. If more smooth rollers are used, then gloss can be regained throughout the printed image. However, if embossing rollers are used, then gloss may be returned to the printed image in areas corresponding to where a roller exerts pressure to the image, e.g., raised areas of the roller(s).

### EXAMPLES

The following examples illustrate the embodiments of the invention that are presently best known. However, it is to be understood that the following are only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following Examples provide further detail in connection with what are presently deemed to be the most practical and preferred embodiments of the invention.

### Example 1

Four pigment-containing ink-jet inks were prepared having the same self-dispersed pigment and liquid vehicle. To the first of the inks was added latex particulates, to the second ink was added polymeric binder, to the third ink was added both latex particulates and polymeric binder, and the fourth ink remained as originally prepared. All four inks were printed on Lustro Laser offset media with and without an underprinted fixer composition. In all cases, the presence of the fixer composition caused a reduction in 60 degree gloss by about 15-25 units compared to ink-jet inks printed without underprinted fixer composition.

### Example 2

A fixer composition, two ink-jet ink compositions, and an overcoat composition were prepared according to Tables 1-4, respectively, as follows:

TABLE 1
Fixer composition

| Component | Wt % |
|---|---|
| Succinic acid | 4 |
| Nitric acid neutralized Lupasol FG | 2.5 |
| Polybiguanide | 0.94 |
| 2-pyrolidinone | 15 |
| Nonionic surfactant | 0.65 |
| Basic Violet 16 | 0.05 |
| Deionized water | balance |

TABLE 2
Ink-jet ink composition

| Components | Wt % |
|---|---|
| LEG-1 | 3 |
| 2-pyrolidinone | 6 |
| Glycerol | 6 |
| 1,2-hexanediol | 4 |
| Nonionic surfactant | 1.9 |
| Pigment solids | 3˜4* |
| Joncryl polymer | 0.4 |
| Deionized water | balance |

*amount depends, in part, on pigment used

TABLE 3
Ink-jet ink composition

| Components | Wt % |
|---|---|
| LEG-1 | 3 |
| 2-pyrolidinone | 5 |
| Glycerol | 4 |
| 1,2-hexanediol | 4 |
| Nonionic surfactant | 1.9 |
| Pigment solids | 3˜4* |
| Latex solids | 3˜3.7* |
| Deionized water | balance |

*amount depends, in part, on pigment and latex used

TABLE 4
Overcoat composition

| Components | Wt % |
|---|---|
| LEG-1 | 3 |
| 2-pyrolidinone | 5 |
| Glycerol | 4 |
| 1,2-hexanediol | 4 |
| Nonionic surfactant | 1.8 |
| Joncryl polymer | 0.4 |
| Deionized water | balance |

### Example 3

The fixer composition of Table 1 was printed onto Lustro Laser offset media in multiple bar patterns. The ink-jet ink of Table 3 was then printed on top of the various bar patterns, followed by the overcoat composition of Table 4. Some of the printed samples were calendared in accordance with embodiments of the present invention, and the remaining samples were not calendared. The calendaring process was carried out by applying 1750 psi of pressure and 52° C. of heat to the printed offset media using a pair of metal rollers at a rate of 37 feet/min. Once the samples were prepared, a yellow alkaline highlighter pen was passed across each of the samples a number of times. Upon smearing, the test was stopped. The printed images that did not undergo a calendaring process began to smear after only four passes of the alkaline pen. The printed images that were calendared did not begin to smear until eight passes of the alkaline pen.

### Example 4

The fixer composition of Table 1 was printed onto Lustro Laser offset media in multiple bar patterns. The ink-jet ink of Table 2 was then printed on top of the various bar patterns, followed by the overcoat composition of Table 4. Some of the printed samples were calendared in accordance with embodiments of the present invention, and other samples were not calendared. The calendaring process was carried out by applying 1750 psi of pressure and 52° C. of heat to the printed offset media using a pair of metal rollers at a rate of 37 feet/min.

The effect of calendaring on gloss was determined by considering the 60 degree gloss of various colors printed. The results are provided in Table 5 below:

TABLE 5
Effect of calendaring on gloss

| | 60 degree gloss | 60 degree gloss |
|---|---|---|
| Printed Color | (before calendaring) | (after calendaring) |
| White | 37 | 44 |
| Black | 15 | 42 |
| Cyan | 15 | 39 |
| Magenta | 18 | 47 |
| Yellow | 19 | 52 |
| Red | 18 | 46 |
| Green | 18 | 46 |
| Blue | 14 | 37 |
| Orange | 22 | 52 |
| Purple | 23 | 46 |
| Light Black | 36 | 56 |
| Light Cyan | 41 | 55 |
| Light Magenta | 42 | 56 |
| Light Yellow | 41 | 58 |
| Light Red | 32 | 56 |
| Light Green | 28 | 53 |
| Light Blue | 26 | 50 |

As can be seen by Table 5, in every case, post calendaring of printed images improved gloss. As Lustro Laser offset media is a glossy paper, the gloss of the image upon post calendaring can be more closely matched to the offset media, thereby improving image quality.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

1. A system for printing durable ink-jet ink images, comprising:
a) offset media;
b) an ink-jet ink including a pigment colorant, said ink-jet ink being configured to be ink-jetted onto the offset media; and
c) a calendaring device configured for applying pressure to offset media once the ink-jet ink is ink-jetted thereon.

2. A system as in claim 1, further comprising a fixer composition including a crashing agent that is reactive with a component of the ink-jet ink, said fixer composition being configured to be overprinted or underprinted on the offset media with respect to the ink-jet ink.

3. A system as in claim 2, wherein the crashing agent is present in the fixer composition at from 0.1 wt % to 10 wt %.

4. A system as in claim 1, further comprising latex particulates dispersed in the ink-jet ink at from 0.1 wt % to 15 wt %.

5. A system as in claim 1, further comprising an overcoat composition including a liquid vehicle having latex particulates dispersed therein, said overcoat composition being configured to be overcoated with respect to the ink-jet ink.

6. A system as in claim 5, wherein the latex particulates are present in the overcoat composition at from 0.1 wt % to 15 wt %.

7. A system as in claim 1, wherein the pressure is mechanical pressure applied at from 500 psi to 3000 psi.

8. A system as in claim 1, wherein the calendaring device is also configured to apply heat.

9. A system as in claim 8, wherein the heat to be applied is from 20° C. to 90° C.

10. A system as in claim 2, wherein the crashing agent is selected from the group consisting of cationic polymers, multivalent metal ions or ionic groups, acids, and combinations thereof.

11. A system as in claim 10, wherein the crashing agent is a cationic polymer selected from the group consisting of polyvinylpyridines, polyalkylaminoethyl acrylates, polyalkylaminoethyl methacrylates, poly(vinyl imidazole), polyethyleneimines, polybiguanides, polyguanides, polyvinylamines, polyallylamines, polyacrylamines, polyacrylamides, polyquaternaryamines, cationic polyurathenes, aminecelluloses, polysacchride amines, and combinations thereof.

12. A system as in claim 10, wherein the crashing agent is a multivalent metal ion or ionic group is provided by a member selected from the group consisting of multivalent metal nitrates, EDTA salts, phosphonium halide salts, organic acids, chloride salts, and combinations thereof.

13. A system as in claim 10, wherein the crashing agent is an acid selected from the group consisting of succinic acid, glycolic acid, citric acid, nitric acid, hydrochloric acid, phosphoric acid, sulfuric acid, polyacrylic acid, acetic acid, malonic acid, maleic acid, ascorbic acid, glutaric acid, fumaric acid, tartaric acid, lactic acid, nitrous acid, boric acid, carbonic acid, carboxylic acids such as formic acid, chloroacetic acid, dichloroacetic acid, trichloroacetic acid, fluoroacetic acid, trimethylacetic acid, methoxyacetic acid, mercaptoacetic acid, propionic acid, butyric acid, valeric acid, caprioc acid, caprylic acid, capric acid, lauric acid, myristic acid, palmitic acid, stearic acid, oleic acid, rinolic acid, rinoleic acid, cyclohexanecarboxylic acid, phenylacetic acid, benzoic acid, o-toluic acid, m-toluic acid, p-toluic acid, o-chlorobenzoic acid, m-chlorobenzoic acid, p-chlorobenzoic acid, o-bromobenzoic acid, m-bromobenzoic acid, p-bromobenzoic acid, o-nitrobenzoic acid, m-nitrobenzoic acid, p-nitrobenzoic acid, oxalic acid, adipic acid, phthalic acid, isophthalic acid, terephthalic acid, salicylic acid, p-hydrobenzoic acid, anthranilic acid, m-aminobenzoic acid, p-aminobenzoic acid, benzenesulfonic acid, methylbenzenesulfonic acid, ethylbenzenesulfonic acid, dodecylbenzenesulfonic acid, 5-sulfosalicylic acid, 1-sulfonaphthalene, hexanesulfonic acid, octanesulfonic acid, dodecanesulfonic acid, amino acids such as glycine, alanine, valine, α-aminobutyric acid, α-aminobutryic acid, α-alanine, taurine, serine, α-amino-n-caprioc acid, leucine, norleucine, phenylalanine, and combinations thereof.

14. A system as in claim 4, wherein the latex particulates comprise randomly polymerized copolymers, said latex particulates being predominantly from 20 nm to 500 nm in size and predominantly from 10,000 Mw to 2,000,000 Mw.

15. A system as in claim 6, wherein the latex particulates comprise randomly polymerized copolymers, said latex particulates being predominantly from 20 nm to 500 nm in size and predominantly from 10,000 Mw to 2,000,000 Mw.

16. A system as in claim 1, wherein the calendaring device includes a pair of rollers that are configured to apply pressure and heat to the offset media once the ink-jet ink is printed thereon.

17. A method of printing images on offset media, comprising:
a) ink-jetting an ink-jet ink onto offset media to form a printed image, said ink-jet ink including a pigment colorant; and
b) applying pressure to the printed image such that a physical property of the printed image is altered by the pressure.

18. A method as in claim 17, further comprising the step of underprinting or overprinting a fixer composition with respect to the ink-jet ink, said fixer composition including a crashing agent that is reactive with a component of the inkjet ink.

19. A method as in claim 18, wherein the crashing agent is present in the fixer composition at from 0.1 wt % to 10 wt %.

20. A method as in claim 17, wherein the ink-jet ink further comprises latex particulates dispersed in the ink-jet ink at from 0.1 wt % to 15 wt %.

21. A method as in claim 17, further comprising the step of overcoating the ink-jet ink that was ink-jetted on the offset media with an overcoat composition, said overcoat composition including from 0.1 wt % to 15 wt % of latex particulates.

22. A method as in claim 17, wherein the pigment colorant is present in the ink-jet ink at from 0.5 wt % to 10 wt %.

23. A method as in claim 17, wherein the step of applying pressure is by applying mechanical pressure at from 500 psi to 3000 psi.

24. A method as in claim 17, further comprising a step of applying heat to the printed image to contribute to the physical property of the image being altered.

25. A method as in claim 24, wherein the applying heat step is at from 20° C. to 90° C.

26. A method as in claim 18, wherein the crashing agent is selected from the group consisting of cationic polymers, multivalent metal ions or ionic groups, acids, and combinations thereof.

27. A method as in claim 20, wherein the latex particulates comprise randomly polymerized copolymers, said latex particulates being predominantly from 20 nm to 500 nm in size and predominantly from 10,000 Mw to 2,000,000 Mw.

28. A method as in claim 21, wherein the latex particulates comprise randomly polymerized copolymers, said latex particulates being predominantly from 20 nm to 500 nm in size and predominantly from 10,000 Mw to 2,000,000 Mw.

29. A method as in claim 17, wherein the physical property is smoothness, wherein upon applying pressure, the printed image is modified from having a textured profile to a smoother profile.

30. A method as in claim 17, wherein the physical property is flow, wherein upon applying pressure, the printed image is temporarily modified from a more solid configuration to a more liquid configuration.
